(19) United States
(12) Patent Application Publication
(10) Pub. No.: US 2021/0022558 A1
(43) Pub. Date: Jan. 28, 2021

(54) CORNER GRIDDLE SPATULA AND SCRAPER

(71) Applicant: Hongyuan Han, New Vernon, NJ (US)

(72) Inventor: Hongyuan Han, New Vernon, NJ (US)

(21) Appl. No.: 16/934,186

(22) Filed: Jul. 21, 2020

Related U.S. Application Data
(60) Provisional application No. 62/877,022, filed on Jul. 22, 2019.

(51) Int. Cl. A47J 43/28

(52) U.S. Cl. CPC A47J 43/288

(57) ABSTRACT

A combination spatula and scraper is disclosed. The spatula/scraper includes a durable handle and a spatula portion. The spatula portion has a first area attached to the durable handle and a second area at an angle to the first area. A corner wall is located on one edge of the spatula portion. The corner wall is connected between an edge of the first area and an edge of the second area.

### STATEMENT REGARDING FEDERALLY SPONSORED RESEARCH OR DEVELOPMENT

N/A

### BACKGROUND OF THE INVENTION

Various embodiments relate generally to spatulas and, more specifically, relate to combinations of spatula and scraper.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Cooking spatulas typically have a broad, flat blade which can be used to mix, spread and lift foods. Spatulas are often used to flip foods during cooking, for example, pancakes.

Since the spatula is able to easily slide beneath foods, when lifting foods, for example, to plate them, the food may slide off the spatula. This may cause the food to fall to the floor or damage the foods.

What is needed is a spatula which can slide beneath foods but also able to keep the foods on the spatula as desired.

### SUMMARY

The below summary is merely representative and non-limiting.

The above problems are overcome, and other advantages may be realized, by the use of the embodiments.

In a first aspect, an embodiment provides a combination spatula and scraper. The spatula/scraper includes a durable handle and a spatula portion. The spatula portion has a first area attached to the durable handle and a second area at an angle to the first area. A corner wall is located on one edge of the spatula portion. The corner wall is connected between an edge of the first area and an edge of the second area.

### BRIEF DESCRIPTION OF THE SEVERAL VIEWS OF THE DRAWINGS

Aspects of the described embodiments are more evident in the following description, when read in conjunction with the attached Figures.

FIG. 1 is a first view of a spatula and scraper in accordance with a first embodiment.

FIG. 2 is a second view of the spatula/scraper of FIG. 1.

FIG. 3 is a third view of the spatula/scraper of FIG. 1.

### DETAILED DESCRIPTION OF THE INVENTION

This patent application claims priority from U.S. Provisional Patent Application No. 62/877,022, filed Jul. 22, 2019, the disclosure of which is incorporated by reference herein in its entirety.

Various embodiments provide a combined spatula and scraper. The combined spatula/scraper includes a durable handle and a spatula portion. The spatula portion having a first area attached to the durable handle and a second area at an angle to the first area. A corner wall on one edge of the spatula portion connects to an edge of the first area and to an edge of the second area so as to create a wall to help to keep food on the spatula during cooking and serving/plating.

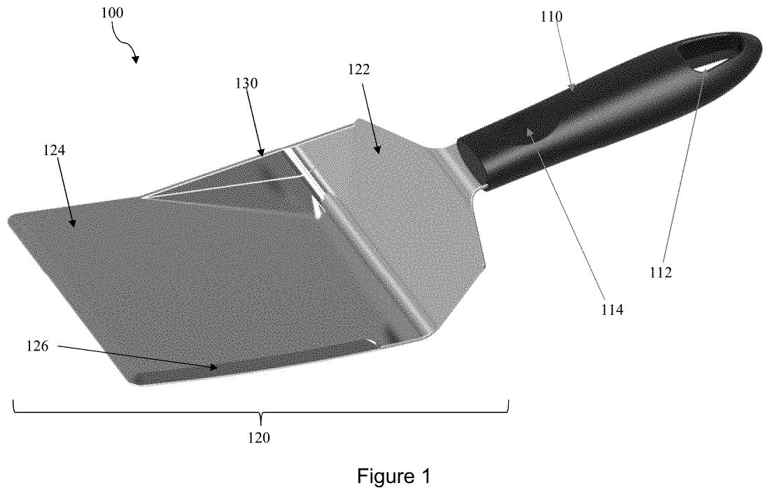

FIG. 1 is a first view of a spatula and scraper 100 in accordance with a first embodiment. The spatula/scraper 100 includes a durable handle 110 and a spatula portion 120. The spatula portion 120 has a first area 122 attached to the durable handle 110 and a second area 124 at an angle to the first area 122. A corner wall 130 is located on one edge of the spatula portion 120. The corner wall 130 is connected between an edge of the first area 122 and an edge of the second area 124.

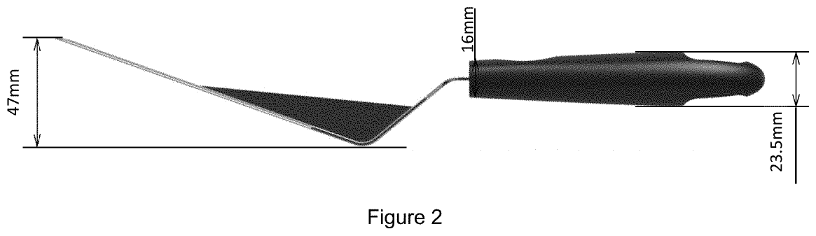

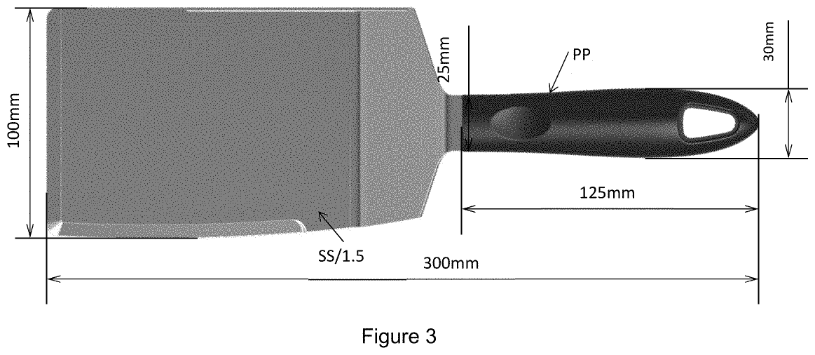

FIGS. 1-3 provide various views of a spatula and scraper 100 in accordance with a first embodiment. As shown in the Figures, the spatula/scraper 100 has a durable kitchen tool handle 110, which may include a hole 112 for hanging. The handle 110 may also include a thumb grip 114. Sharpened edges 126 on the spatula portion 120 help to slide the spatula/scraper 100 under cooking foods more easily. They may also allow the spatula/scraper 100 to cut food in order to check the doneness of food while cooking.

The corner wall 130 is located on one side of the spatula/scraper 100. The corner wall 130 may also include a slot or holes in order to allow straining of the foods during cooking or plating.

The spatula portion 120 may be made of metal, for example, stainless steel, or plastic. The handle 110 may be made with wooden or plastic.

In a further, non-limiting embodiment the spatula portion 120 may have a non-stick coating.

The foregoing description has been directed to particular embodiments. However, other variations and modifications may be made to the described embodiments, with the attainment of some or all of their advantages. Modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A combination spatula and scraper comprising:
durable handle;
a spatula portion, the spatula portion having a first area attached to the durable handle and a second area at an angle to the first area; and
a corner wall on one edge of the spatula portion, the corner wall connected to an edge of the first area and to an edge of the second area.

2. The combination spatula and scraper as in claim 1, wherein the second area has at least one sharpened edge.

3. The combination spatula and scraper as in claim 1, wherein the durable handle defines a hole for hanging.

4. The combination spatula and scraper as in claim 1, wherein the durable handle defines a thumb grip.

5. The combination spatula and scraper as in claim 1, wherein the corner wall defines at least one drain opening.

6. The combination spatula and scraper as in claim 1, wherein the corner wall defines at least one slot.

7. The combination spatula and scraper as in claim 1, wherein the durable handle comprises at least one of: plastic and wood.

8. The combination spatula and scraper as in claim 1, wherein the spatula portion comprises at least one of: stainless steel and plastic.

9. The combination spatula and scraper as in claim 1, wherein the spatula portion comprises a non-stick coating.
